(19) United States
(12) Patent Application Publication
(10) Pub. No.: US 2015/0120007 A1
(43) Pub. Date: Apr. 30, 2015

(54) Adaptive Fall and Collision Detection and Injury Mitigation System and Method

(71) Applicants: Allon Guez, Penn Valley, PA (US); Helen Guez, Penn Valley, PA (US)

(72) Inventors: Allon Guez, Penn Valley, PA (US); Helen Guez, Penn Valley, PA (US)

(21) Appl. No.: 14/520,385

(22) Filed: Oct. 22, 2014

Related U.S. Application Data
(60) Provisional application No. 61/895,589, filed on Oct. 25, 2013.

(51) Int. Cl. G05B 13/02; G06N 99/00; G01P 13/00

(52) U.S. Cl. CPC G05B 13/0205; G01P 13/00; G06N 99/005
USPC 700/47; 700/67; 700/90; 700/245

(57) ABSTRACT

A safety device assembly is disclosed. The assembly includes a brain signal sensor adapted to receive a first electrical signal and to transmit a first electronic signal based on the first electrical signal, a muscular signal sensor adapted to receive a second electrical signal and to transmit a second electronic signal based on the second electrical signal, and a movement sensor adapted to sense movement and to transmit a third electronic signal based on the movement. A processor is electronically coupled to the brain signal sensor, the muscular signal sensor, and the movement sensor. The processor is configured to process the first electronic signal, the second electronic signal, and the third electronic signal and generate a result. A safety device is electronically coupled to the processor such that, when the result meets a predetermined threshold, the safety device is activated.

### CROSS-REFERENCE TO RELATED APPLICATIONS

This application claims the benefit of the filing date of U.S. provisional application No. 61/895,589, filed Oct. 25, 2013, the teachings of which are incorporated herein by reference.

### BACKGROUND OF THE INVENTION

1. Field of the Invention

The present invention relates to a system for protecting a person from injuries that may otherwise be sustained by a fall, collision, or other bodily impact.

2. Description of the Related Art

Many elderly tend to be prone to losing their balance and falling. Such falls result in breaks, fractures, and even mortalities. According to the Centers for Disease Control, the annualized rate of fall/collision injury episodes for adults, aged 65 years and over who were not institutionalized in 2001-2003, was 51 episodes per 1,000 people. Annually, one in three Americans over the age of 65 experiences a fall/collision and many of these falls/collisions are recurrent. Further, nearly 60% of older adults who experienced injuries due to falling visited an emergency room for treatment or advice.

EEG, NIRS, and other neural-imaging techniques are becoming more useful in being able to detect certain states of mind prior to the subject actually knowing how he or she feels. It is known that brain signals can be used to indicate a person's current activity state and to predict a change in the person's activity state.

It would be beneficial to provide a system and a method for detecting body signals indicative of an imminent fall and activating a safety device to mitigate damage or injury resulting from the fall. Furthermore, due to vast variations in the causes, pathologies and scenarios of falling, such a system should be capable of adapting its performance to the specific and individual user.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a safety system comprising a brain signal sensor adapted to receive a first electrical signal and to transmit a first electronic signal based on the first electrical signal, a muscular signal sensor adapted to receive a second electrical signal and to transmit a second electronic signal based on the second electrical signal, and a movement sensor adapted to sense movement and to transmit a third electronic signal based on the movement. A processor is electronically coupled to the brain signal sensor, the muscular signal sensor, and the movement sensor. The processor is configured to process the first electronic signal, the second electronic signal, and the third electronic signal and generate a result. A safety device is electronically coupled to the processor such that, when the result meets a predetermined threshold, the safety device is activated.

In another embodiment, the present invention is a method of mitigating bodily injury, comprising the steps of using the safety system described above; receiving the first electrical signal, the second electrical signal, and the movement sensation; generating the first electronic signal, the second electronic signal and the third electronic signal based on the first electrical signal, the second electrical signal, and the movement sensation, respectively; processing the first electronic signal, the second electronic signal, and the third electronic signal at the processor to generate a result; transmitting an activation signal to the safety device if the result meets a threshold value; and activating the safety device.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a schematic drawing of a fall and collision detection and injury mitigation system according to an exemplary embodiment of the present invention;

FIG. 2 shows a deployable airbag that can be used with the fall and collision detection and injury mitigation system of FIG. 1;

FIG. 3 shows an exoskeleton that can be used with the fall and collision detection and injury mitigation system of FIG. 1; and

FIG. 4 is a flowchart describing an exemplary signal and information flow as well as exemplary modules for providing adaptation and tuning capabilities of the system for individual users.

### DETAILED DESCRIPTION OF THE PRESENT INVENTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Referring in general to the Figures, a fall and collision detection and injury mitigation system 100 (“system 100”) according to an exemplary embodiment of the present invention is disclosed. System 100 uses physiological and movement data to anticipate when a person (“the user”) wearing system 100 is in imminent danger or is in fact falling and activates an injury mitigation device to attempt to minimize potential injury from the fall or to prevent fall altogether.

System 100 is comprised of a plurality of sensors attached to the user that measure physiological and physical data and transmit that data to a processor, which in turn determines whether the data are indicative of an imminent fall. If so, the processor transmits an electronic signal to activate the injury mitigation device.

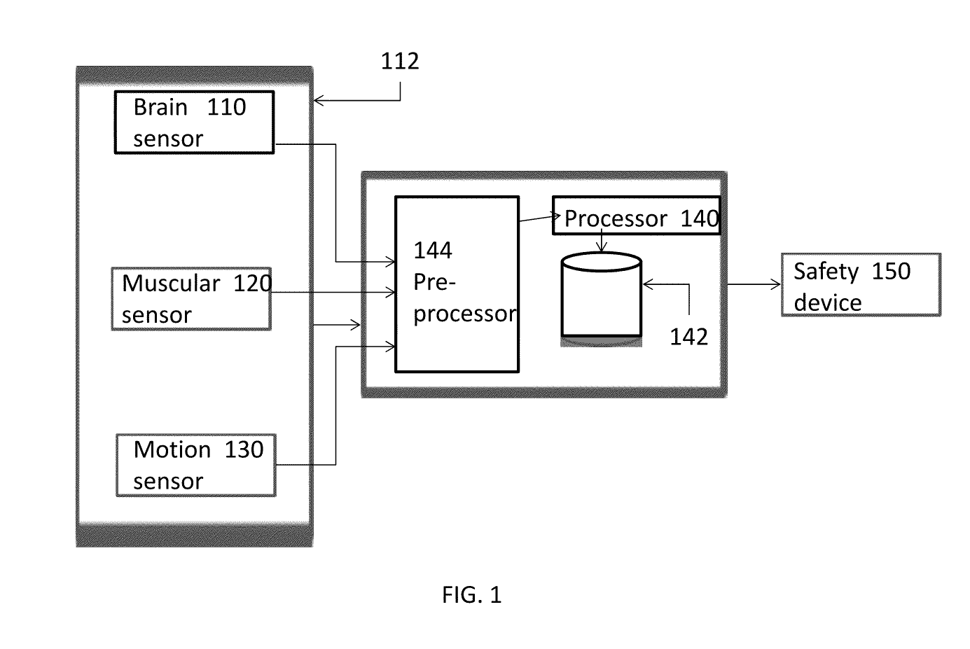

Referring specifically to FIG. 1, electronic schematic of system 100 is shown. System 100 includes a brain sensor 110 that is adapted to receive a first electrical signal and to transmit a first electronic signal based on the first electrical signal. In an exemplary embodiment, brain sensor 110 can be an electro-encephalocardiogram (“EEG”) sensor, a near infrared sensor (NIRS), or other known or as yet unknown type of brain sensor. In an exemplary embodiment, brain sensor 110 can be attached (invasively or non-invasively based on the brain sensor type) to the user's forehead, skull, top of the neck or back of the head depending on the specific neural tissue such as, for example, the vestibular system, Central Nervous System or peripheral nervous system that is being tracked.

System 100 also includes a muscular sensor 120 that is adapted to receive a second electrical signal and to transmit a second electronic signal based on the second electrical signal. In an exemplary embodiment, muscular sensor can be an electromyography (“EMG”) sensor, or other known or as yet unknown type of muscular sensor. In an exemplary embodiment, muscular sensor 120 can be attached to the user's thighs, picking up sensory information from quadriceps or hamstrings; upper arms; neck; or other muscle groups whose reflexive electrical activation is being pursued and monitored.

System 100 also includes a movement sensor 130 that is adapted to sense movement and to transmit a third electronic signal based on the movement. In an exemplary embodiment, movement sensor 130 can be an accelerometer, gyro or other known or as yet unknown type of velocity, displacement, acceleration, jerk or other movement sensor. In an exemplary embodiment, movement sensor 130 can be attached to the user's chest. Sensor 130, however, may be located anywhere on the user's core and head, depending on the product design, convenience, and other potential user disabilities.

While FIG. 1 shows brain sensor 110, muscular sensor 120, and movement sensor 130 as three separate sensors, in an exemplary embodiment, brain sensor 110, muscular sensor 120, and movement sensor 130 can be provided as a single unit 112 that needs only to be attached to a single location on the user. An exemplary location for single unit 112 can be on the back of the user's neck. In this location, brain sensor 110, is able to sense neurological signals generated by the vestibular nuclei, on either side of the brain stem. Muscular sensor 120 can alternatively be used to sense movement of the trapezius and sternocleidomastoid muscles of the neck and movement sensor 130 can sense movement of the user's body.

A processor 140 is electronically coupled to brain signal sensor 110, muscular signal sensor 120, and movement sensor 130. Processor 140 is configured to process the first electronic signal, the second electronic signal, and the third electronic signal and generate a result. Processor 140 can be an electronic microprocessor and is powered by an electrical power source, such as a battery (not shown).

Processor 140 can include a memory 142 for data storage to store pluralities of the first electronic signal, the second electronic signal, and the third electronic signal. A signal preprocessor 144 can optionally be provided to preprocess the electrical signals received from brain signal sensor 110, muscular signal sensor 120, and movement sensor 130. Processor 140 computes with a plurality of signal processing algorithms, either available in public domain (machine learning, pattern recognition, neural-networks, adaptive control, filtering, online optimization and many other well known or yet-to-be-developed techniques) or customized by the designer to accommodate desired operation of system 100. Processor 140 also implements training/adaptation/customization algorithms in order to adjust for the expected variations in the required alarm threshold and proper activation of the safety device for each user.

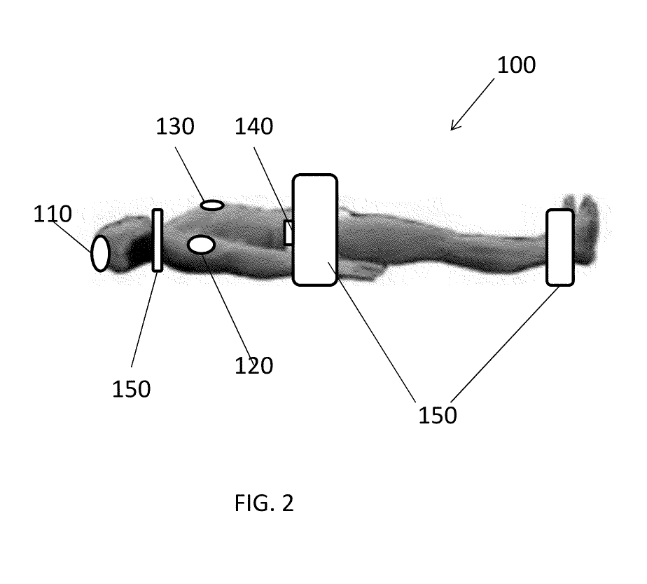

A safety device 150 is electronically coupled to processor 140 such that, when the result meets a predetermined threshold value as determined by the software/hardware-based algorithms, safety device 150 is activated. As shown in FIG. 2, safety device 150 can be a deployable airbag 152 or a plurality of airbags 152. Airbag 152 can be worn about the user's waist, neck/collar, and/or ankles and can be secured to the user by a releasable securing mechanism, such as, for example, a hook and loop attachment. An exemplary airbag that can be used with the present invention is disclosed in U.S. Pat. No. 7,017,195 to Bachman et al., which is incorporated herein by reference. Safety device 150 can be a disposable, for one time use or a multiple usage system.

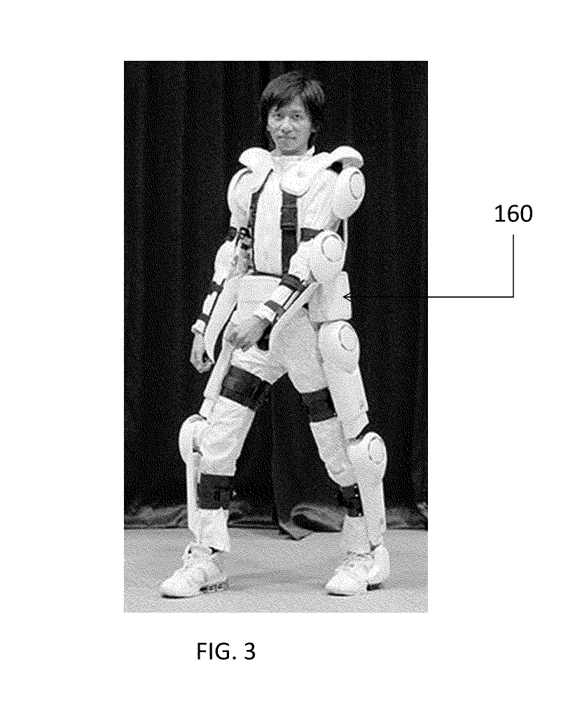

Alternatively, safety device 150 can be another type of safety device, such as, for example, an exoskeleton 160, shown FIG. 3. Exoskeleton 160 can be worn by the user and can be activated to become rigid to prevent the user from falling upon determination by processor 140 that the user has imminent likelihood of falling. Safety device 150 can be disposable, for one time use or a multiple usage system.

System 100 can be triggered to activate when the user experiences different sensations. For example, system 100 can activate when the user senses an impending fall and actually begins to fall. Alternatively, system 100 can activate when the user faints or passes out (having no sense of an impending fall), and actually begins to fall.

Prior to a user initiating use of system 100, it may be desirable for the user to “train” system 100 with regard to typical movements of user that may be associated with particular brain and or muscular signals. For example, user can be connected to system 100 and blindfolded or immersed in a virtual reality system, such as, for example, developed by Oculus VR, LLC, located in Irvine, Calif. The user can then be provided with the sensation of falling while recording brain activity with brain signal sensor 100, muscle activity with muscular signal sensor 120 and movement with movement sensor 130. This process can be repeated a plurality of times. Processor 140 determines brain and muscular signals associated with the user sensing and reacting to an impending fall and uses the values of such signals to determine threshold values for activating safety device 150. Thus, processor 140 also implements training/adaptation/customization algorithms in order to adjust for the expected variations in the required alarm threshold and proper activation of the safety device per each user.

In operation, using system 100 with brain signal sensor 110, muscular signal sensor 120, and movement sensor 130 attached to the user, when the user is about to fall, brain signal sensor 110 receives a first electrical signal from the brain, indicating a significant increase in brain activity, resulting from the user realizing that he/she is about to fall. Brain signal sensor 110 generates a first electronic signal based on the first electrical signal and transmits the first electronic signal to processor 140.

Within a first, short period of time of the user's brain generating the first electrical signal, such as, for example, within a range of about 50 to about 200 ms, muscular signal sensor 120 receives a second electrical signal from the user's musculature, indicating a sudden contraction of muscles to brace the user for the impending fall, such signal may be received for example, within the range of between about 100 to about 800 ms. If such muscular activity is present, muscular signal sensor 120 generates a second electronic signal based on the second electrical signal and transmits the second electronic signal to processor 140. If such a movement is experienced, movement sensor 130 receives a movement sensation from the user, indicating the likely start of the fall. Movement sensor 130 generates a third electronic signal based on the movement sensation and transmits the third electronic signal to processor 140.

Processor 140 processes the first electronic signal, the second electronic signal, and the third electronic signal to generate a result and transmits an activation signal to safety device 150 if the data as processed by the algorithms warrants that the result meets a threshold value. The activation signal activates safety device 150 to mitigate damage and/or injury to the user when the user falls.

Alternatively, if the user faints or otherwise loses consciousness and falls due to his/her loss of consciousness, system 100 can activate safety device 150 based on a different set of parameters. In such a situation, brain signal sensor 110 receives a first electrical signal from the brain, indicating a significant decrease in brain activity, resulting from the user losing consciousness. Brain signal sensor 110 generates a first electronic signal based on the first electrical signal and transmits the first electronic signal to processor 140.

Within a first, short period of time of the user's brain generating the first electrical signal, muscular signal sensor 120 receives a second electrical signal from the user's musculature, indicating a sudden change of activation of muscles, also due to loss of consciousness. Muscular signal sensor 120 generates a second electronic signal based on the second electrical signal and transmits the second electronic signal to processor 140. Within a second, short period of time of the musculature generating the second electrical signal, movement sensor 130 receives a movement sensation from the user, indicating the start of the fall. Movement sensor 130 generates a third electronic signal based on the movement sensation and transmits the third electronic signal to processor 140.

Processor 140 processes the first electronic signal, the second electronic signal, and the third electronic signal to generate a result and transmits an activation signal to safety device 150 if the data as processed by the algorithms warrants that the result meets a threshold value. The activation signal activates safety device 150 to mitigate damage and/or injury to the user when the user falls.

Therefore, by way of example only, if the first electrical signal from the brain that is received by brain signal sensor 110 is above a first brain signal threshold level, and if the second electrical signal received from the musculature that is received by muscular signal sensor 120 is above a first musculature signal threshold level, processor 140 interprets those signals as the user realizing that he/she is about to fall and waits for movement sensor 130 to determine that the user is actually falling before transmitting the signal to activate safety device 150.

Alternatively, if the first electrical signal from the brain that is received by brain signal sensor 110 is below a second brain signal threshold level, less than the first brain signal threshold level, and if the second electrical signal received from the musculature that is received by muscular signal sensor 120 is below a second musculature signal threshold level, less than the first muscular signal threshold level, processor, 140 interprets those signals as the user fainting and waits for movement sensor 130 to determine that the user is actually falling before transmitting the signal to activate safety device 150.

While system 100 is described above as requiring activation of brain signal sensor 110, muscular signal sensor 120, and movement sensor 130 in a specific order in order to activate safety device 150, the present invention also contemplates activation of brain signal sensor 110, muscular signal sensor 120, and movement sensor 130 in different time sequential order, as well as the activation of only one or two of brain signal sensor 110, muscular signal sensor 120, and movement sensor 130 in order to activate safety device 150.

Additionally, instead of requiring specific timing or sequence of activation of brain signal sensor 110, muscular signal sensor 120, and movement sensor 130, in order to activate safety device 150, those skilled in the art will recognize that other known types of mechanisms and techniques, such as, for example, machine learning, pattern recognition, neural networks, adaptive control, filtering, and -line optimization can be used to determine whether the user is sensing an impending and/or actual fall and activate safety device 150.

System 100 also has the ability to “learn” the user and recalibrate the threshold values for activation of safety device 150 based on the user and the user's daily activities. For example, of the first electronic signal exceeds the value that would otherwise indicate that the brain may be sensing an impending fall, but neither the second nor the third electronic signal exceeds the values that would otherwise indicate that the musculature may be sensing an impending fall, or movement of the body indicates an actual fall, the threshold value of the first electronic signal may be raised. Similarly, the threshold values for either/both the second and third electronic signals, respectively, can be recalibrated if the remaining electronic signals do not indicate an impending fall.

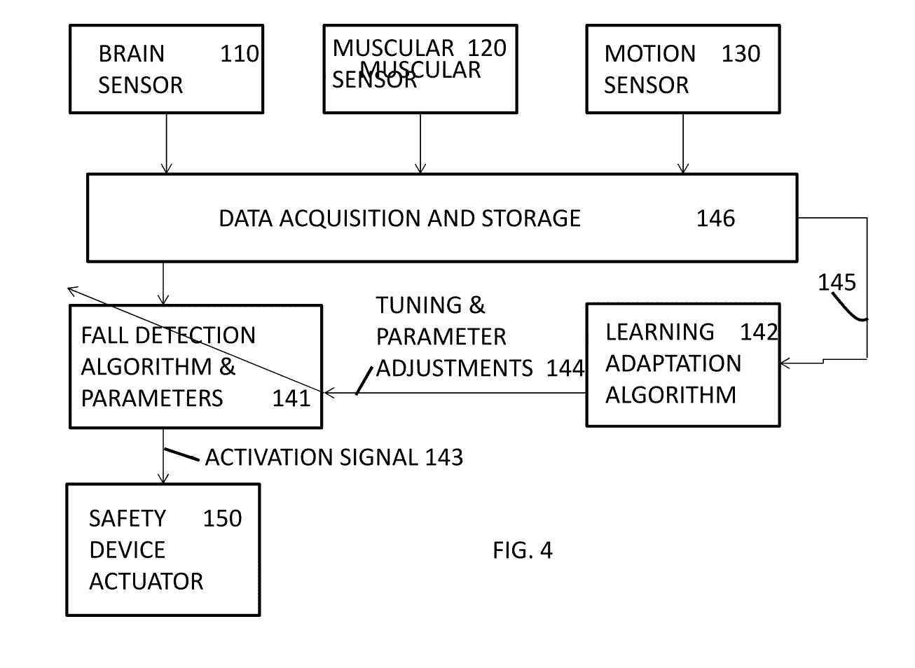

A flowchart 400 describing an exemplary arrangement and operation implementing the “learning”/adaptation of system to a specific user is shown in FIG. 4. Module 141 provides the currently operational fall detection algorithm and parameters; module 142 is a learning adaptation algorithm; module 143 is an actual activation signal; module 144 is a tuning and parameter adjustment signal; module 145 is the access to historical measurements data for learning; and module 146 is data acquisition and storage.

An exemplary method of adaptation occurs as follows. Module 142 constantly monitors correlation between the actual activation 143 and the sensory data in 146 received by brain sensor 110, muscular sensor 120, and motion sensor 130 and adjusts the parameters in 141 whenever a “mismatch” is present, meaning that, whenever activation signal 141 activates safety device 150 but no falls occurred, or alternatively, when a fall occurs with safety device 150 not being activated. Common gradient descent, least square estimation, adaptive control, machine learning and other known adaptive signal processing techniques may be employed for such adjusting.

It will be further understood that, as for example many other safety device activation command algorithms may be implemented based on public domain techniques such as machine learning, adaptive control, sensors fusion, signal processing etc., various changes in the details, materials, and arrangements of the parts which have been described and illustrated in order to explain the nature of this invention may be made by those skilled in the art without departing from the scope of the invention as expressed in the following claims.

We claim:

1. A safety system comprising:
(a) a brain signal sensor adapted to receive a first electrical signal and to transmit a first electronic signal based on the first electrical signal;
(b) a muscular signal sensor adapted to receive a second electrical signal and to transmit a second electronic signal based on the second electrical signal;
(c) a movement sensor adapted to sense movement and to transmit a third electronic signal based on the movement;
(d) a processor electronically coupled to the brain signal sensor, the muscular signal sensor, and the movement sensor, the processor configured to process the first electronic signal, the second electronic signal, and the third electronic signal and generate a result; and
(e) a safety device electronically coupled to the processor such that, when the result meets a predetermined threshold value, the safety device is activated.

2. The safety system according to claim 1, wherein the brain signal sensor, the muscular signal sensor, and the movement sensor comprise a single unit.

3. The safety system according to claim 1, wherein the predetermined threshold value comprises a first level and a second level, greater than the first level, the predetermined threshold being a lesser value than the first level and a greater value than the second level.

4. The safety system according to claim 1, wherein the safety device comprises at least one deployable airbag.

5. The safety system according to claim 1, wherein the safety device comprises an exoskeleton.

6. The safety system according to claim 1, wherein the processor stores pluralities of the first electronic signal, the second electronic signal, and the third electronic signal, and, wherein the predetermined threshold value is revised based on values of the pluralities of the first electronic signal, the second electronic signal, and the third electronic signal.

7. The safety system according to claim 6, further comprising:
a data storage operatively coupled to processor, wherein the data storage is adapted to store values relating to the first electronic signal, the second electronic signal, and the third electronic signal; and
a learning adaptation algorithm operatively coupled to the data storage, wherein the learning adaptation algorithm revises the threshold value.

8. A method of mitigating bodily injury, comprising the steps of:
(a) using the safety device assembly according to claim 7;
(b) receiving the first electrical signal, the second electrical signal, and the movement sensation;
(c) generating the first electronic signal, the second electronic signal and the third electronic signal based on the first electrical signal, the second electrical signal, and the movement sensation, respectively;
(d) processing the first electronic signal, the second electronic signal, and the third electronic signal at the processor to generate a result;
(e) transmitting an activation signal to the safety device if the result meets a threshold value; and
(f) activating the safety device.

9. The method according to claim 8, wherein step (e) is performed only if the third electronic signal exceeds a predetermined movement value.

10. The method according to claim 8, wherein the threshold value is either:
i. a lesser value than a first value; or
ii. a greater value than a second value, the second value being greater than the first value.

11. The method according to claim 8, wherein, after step (d), the result is stored in the processor.

12. The method according to claim 11, further comprising the step of comparing the result to prior results stored in the processor and, if step (e) was not performed subsequent to the generation of the prior results, revising the threshold value.

13. The method according to claim 12, wherein the step of revising the threshold value comprises the learning adaptation algorithm adjusting operational parameters when a mismatch between an activation signal and an actual occurrence is detected.

14. A method of activating an injury mitigation device comprising:
(a) using the safety device assembly according to claim 1; and
(b) activating the safety device when the predetermined threshold value is met.

15. The method according to claim 14, wherein the predetermined threshold value is met when one of the following parameters is met:
i. the first electronic signal indicates a sensation of an impending fall; or
ii. the second electronic signal indicates a muscle constriction as an indication of bracing for a fall; and
when the third electronic signal indicates bodily movement as an indication of an actual fall.

16. The method according to claim 15, wherein both of parameters i. and ii. are met.

17. The method according to claim 16, wherein the second electronic signal is generated within a first predetermined time frame from generation of the first electronic signal, and wherein the third electronic signal is generated within a second predetermined time frame from the generation of the first electronic signal.

18. The method according to claim 14, wherein the predetermined threshold value is met when one of the following parameters is met:
i. the first electronic signal indicates a sudden decrease in brain activity; or
ii. the second electronic signal indicates a muscle relaxation; and
when the third electronic signal indicates bodily movement as an indication of an actual fall.

19. The method according to claim 18, wherein both of parameters i. and ii. are met.

20. The method according to claim 19, wherein the second electronic signal is generated within a first predetermined time frame from generation of the first electronic signal, and wherein the third electronic signal is generated within a second predetermined time frame from the generation of the first electronic signal.
